(19) United States
(12) Patent Application Publication
(10) Pub. No.: US 2015/0329071 A1
(43) Pub. Date: Nov. 19, 2015

(54) Battery life saving system

(71) Applicant: Jaroslaw Zygula, Elmwood Park, IL (US)

(72) Inventor: Jaroslaw Zygula, Elmwood Park, IL (US)

(21) Appl. No.: 14/109,937

(22) Filed: May 19, 2014

(51) Int. Cl. B60R 16/03

(52) U.S. Cl. CPC B60R 16/03

(57) ABSTRACT

I claim that the battery life save system will increase the effective life a vehicle battery and also improve the engine ignition process. The system works by temperately shutting off electronic components of the vehicle that are not essential to the ignition process, including but not limited to exterior lights, interior lights, entertainment system, suspension, ABS and other components that are not essential to the ignition process. Shutting off these components will decrease the electrical usage of the vehicle and allow for more of the electricity to be used in the ignition process, making the process more efficient, this will also protect the battery by not exposing it to periods of very high electrical consumption thus extending its life.

The battery saver system delays or temporarily turns off electrical and electronic components of the vehicle that are not essential to the engine start up process. The components that would be switched off during the engine start up process include:
external lights including headlights,
Heating/Air conditioning
entertainment system (radio, navigation, audio, video)
ABS
suspension system
trans axcel (transmission, four wheel drive system, differentials)
and any other vehicle components not essential to the engine start up process.

During the engine start up process the starter motor will be receiving the most energy from the battery, this makes it important to keep the other components off, so the starter motor gets the highest voltage possible to make the engine cranking easier and to send the maximum amount of power to the engine management system. During cold weather starts the power of the battery is reduced by the low temperatures, this makes it even more important to have all the power from the battery go to the starter motor and the engine management system. Periods of heavy voltage consumption can cause damage to the battery cells. If the battery is not exposed to heavy electrical usage that usually happens during the start up process, the life time of the batter will extended.

1. I claim that during the ignition process of an automobile engine, temperately shutting off components that are not essential to the ignition process, including A/C, exterior lighting, entertainment system and other electronic equipment that is not essential to the ignition process will improve the ignition process and will also extend the life of the batter by decreasing periods of very high electricity usage that happen during the ignition process.
